(19) United States
(12) Patent Application Publication
(10) Pub. No.: US 2016/0020528 A1
(43) Pub. Date: Jan. 21, 2016

(54) FEMALE ELECTRICAL CONTACT PART AND METHOD OF FORMING SAME

(71) Applicant: Yazaki Corporation, Tokyo (JP)

(72) Inventor: Daisuke Miyakawa, Susono-shi (JP)

(21) Appl. No.: 14/799,767

(22) Filed: Jul. 15, 2015

(30) Foreign Application Priority Data
Jul. 17, 2014 (JP) 2014-146888

(51) Int. Cl. H01R 4/16; H01R 43/16; H01R 4/18

(52) U.S. Cl. CPC H01R 4/16; H01R 4/18; H01R 43/16

(57) ABSTRACT

Disclosed is a female electrical contact part including a cylindrical wall having at a front end side an opening for insertion of a male electrical contact part, a cutout hole provided on the cylindrical wall at a position spaced rearward from the opening, an elastic contact segment protruding diagonally rearward from a front end of the cutout hole toward inside of the cylindrical wall, and an elastic auxiliary segment protruding diagonally forward from a rear end of the cutout hole toward inside of the cylindrical wall and supporting at a front end an outer surface of the rear end of the elastic contact segment.

### BACKGROUND OF THE INVENTION

1. Field of the Invention

The present invention relates to a female electrical contact part with an enhanced contact force against a male electrical contact part and a method for forming the female electrical contact part.

2. Description of the Related Art

Conventionally, in order to firmly elastically contact with good contact pressure an elastic contact portion in a female electrical contact part of a terminal to a male electrical contact part of a mating terminal for example, there have been proposed a variety of female electrical contact parts and methods of forming the female electrical contact part.

For example, the Patent Literature 1, as shown in FIG. 10, discloses that a female electrical contact part of a female terminal (socket terminal) 51 is constituted by a cylindrical portion 54 including an elastic contact segment 53 of three pieces that are arranged at equal intervals in a circumferential direction and a separated spring ring 55 that is fitted around an outer peripheral of the cylindrical wall 54 and presses each elastic contact segment 53 in a diameter-reduced direction.

Each elastic contact segment 53 is divided into each other by a slits 56 extending in an axial direction. An upper center slit 56 is seam when the cylindrical portion 54 is processed rounded. Two elastic contact segments 53 located at both sides of the center slit 56 is provided with rear and forth projections 57 engaging with and position the spring ring 55. A female electrical contact part 52 continues to a rearward wire connecting portion 58. A not-shown contact portion is formed projecting on an inner surface of each elastic contact segment 56. The female terminal 51 connected with electrical wire (not shown) is housed in a not-shown connector housing so as to constitute a connector.

The female terminal 51 accommodating the connector is fitted in a mating connector that houses a not-shown male terminal (pin terminal), and the male electrical contact part of the male terminal (round pin) is inserted into and connected to the female electrical contact part 52 of the female terminal 51. For example, the electric wire connected to the female terminal 51 is connected to an inverter of a hybrid car, and the electric wire connected to the male terminal is connected to a motor.

Also, the Patent Literature 2 (not shown) discloses that a pair of elastic arms substantially the same sized and shaped is stacked across substantially the entire length in the thickness direction (a radial direction of the electrical contact part) on a substantially cylindrical female electrical contact part (terminal connecting portion) of the female terminal, and a contact load for a mating pin-like male terminal is secured by an elastic contact segment constituted by a pair of elastic arms (elastic segments).

A pair of inward projections (an indented portion), in addition to the elastic contact segment made of the pair of elastic arms, is formed on the cylindrical portion of the female electrical contact part, spaced apart in a circumferential direction. A mating male terminal is inserted in a cylindrical portion of the female electrical contact part and is in contact with the male terminal at three points of the elastic contact segment and a pair of projections.

When processing of the female electrical contact part, firstly by punching a single plate-like metal material a portion corresponding to the pair of elastic arm portions is integrally formed spaced in a width direction of metallic material. Then, the metal material is bent through press or cold forging process into a cylindrical shape, and the pair of elastic arms is bent into a required shape as well and is stacked over substantially the entire length in the thickness direction. The female electrical contact part including the pair of elastic arms is integrally formed of the same metal material.

### PATENT LITERATURE

### Patent Literature 1

### Japanese Patent Publication No. 2011-193677 (FIGS. 1 to 4)

### Patent Literature 2

### Japanese Patent Publication No. 2011-159606 (FIGS. 1 and 7)

### SUMMARY OF THE INVENTION

Disadvantageously, the female electrical contact part 52 described in Patent Literature 1 (FIG. 10), as is constituted by a cylindrical portion 54 of two parts including the elastic contact segment 53 and the separated spring ring 55, may incur increase of assembly work and cost.

Also, the female electrical contact part and the female electrical contact part disclosed in Patent Literature 2 (not shown), as the pair of elastic arm portions is formed in substantially the same size and shape, and is stacked over the entire length of the elastic arm, may need the metal material of larger area (base material), becoming complex and further weighted in a structure of the female electrical contact part.

In view of the points described above the present invention is intended to provide a female electrical contact part and a method of making the female electrical contact part with a simple and compact structure and capable of securely exerting a good contact load for the male electrical contact part.

To achieve the above object, a female electrical contact part according to a first aspect includes a cylindrical wall having an opening near a front end for inserting a male electrical contact part; a cutout hole provided on the cylindrical wall at a position spaced rearward from the opening; an elastic contact segment protruding diagonally backward from a front end of the cutout hole toward inside of the cylindrical wall; and an elastic auxiliary segment protruding diagonally forward from a rear end of the cutout hole toward inside of the cylindrical wall and supporting at a front end portion an outer surface of the rear end of the elastic contact segment.

With the above shape portion, when the male electrical contact part is inserted from the opening of the cylindrical wall of the female electrical contact part in the cylinder wall, while the inner surface of the rear end (a distal end) of the elastic contact segment is in contact with the outer surface of the male electrical contact part, the elastic contact segment is pressed outwardly by the outer surface of the male electrical contact part so as to be bent, the front end portion (a distal end) of the elastic auxiliary segment abuts on the outer surface of the rear end of the elastic contact segment, thereby suppressing outward deflection of the elastic contact segment. Furthermore, when the elastic contact segment is pressed outwardly by the outer surface of the male electrical contact part to be bent, the front end of the elastic auxiliary segment is pressed outwardly by the rear end of the elastic contact segment to be bent, and thereby the elastic contact segment is brought into contact with the male electrical contact part by the sum spring force (contact load) of that of the elastic contact segment and that of the elastic auxiliary segment. Thereby, a good contact load respective to the male electrical contact part is surely exerted. Moreover, since the elastic contact the cylindrical wall and the elastic auxiliary segment are formed integrally on the cylindrical wall, the structure becomes simplified and compact.

Preferably, in the female electrical contact part of the first aspect, an outer surface of a rear end of the elastic contact segment and an inner surface of the front end portion of the elastic auxiliary segment may be in surface contact.

With the above structure, since the elastic contact segment which is inclined inwardly from the front end toward the rear of the cutout hole of the cylinder wall and the elastic auxiliary section which is inclined inwardly from the rear end toward the front of the cutout hole are in surface contact at each distal end, for example, when the male electrical contact part is inserted from an oblique direction, or is vibrated when mounted in a vehicle, the front end of the elastic auxiliary segment, without being detached from the rear end of the elastic contact segment, firmly supports the rear end of the elastic contact segment.

Preferably, in the female electrical contact part, the cutout hole, the elastic contact segment, and the elastic auxiliary segment may be provided on the cylindrical wall in one or more pairs.

With the above structure, the elastic contact segment is respectively supported by the elastic auxiliary segment, each contact load of the elastic contact segment for the male electrical contact part satisfactorily exhibits. Though the number of the elastic contact segment and the elastic auxiliary segment increase, as the elastic contact segment and the elastic auxiliary segment are each formed integrally with the single cylindrical wall, an easy and compact technical structure are maintained.

A method of forming a female electrical contact part according to a second aspect, including the steps of: cutting and raising a mountain-shaped elastic segment corresponding portion at a plate-like unfolded cylindrical wall portion made of conductive metal; cutting the mountain-shaped elastic segment corresponding portion from a top portion thereof so as to form one elastic segment and the other elastic segment; punching or drawing the other elastic segment so as to lie lower and further outward than the one elastic segment, or drawing the one elastic segment so as to lie higher and further inward than the other elastic segment; supporting an outer surface of a distal end of the one elastic segment as an elastic contact segment with a distal end of the other elastic segment as an elastic auxiliary segment.

With the above structure, the unfolded cylindrical wall portion is bent into the cylinder wall, and the elastic contact segment of the one elastic segment and the other elastic auxiliary segment of the other elastic segment are integrally formed on the cylindrical wall. When the male electrical the contact portion is inserted from the opening of the cylindrical wall of the female electrical contact part into the cylinder wall, while the inner surface of the distal end portion of the elastic contact segment contacts the outer surface of the male electrical contact part, the elastic contact segment is pressed outward by the outer surface of the male electrical contact part to be bent, the tip portion of the elastic auxiliary section is in contact with the outer surface of the distal end portion of the elastic contact segment, suppressing the outward deflection of the elastic contact segment. Also, when the elastic contact segment is pressed outwardly by the outer surface of the male electrical contact part, the tip of the elastic auxiliary segment is pressed outward at the distal end of the elastic contact segment, the elastic contact segment is in contact with the elastic contact segment by a sum spring force (contact load) of spring forces of the elastic contact segment and the elastic auxiliary segment. It follows from this that good contact load for the male electrical contact part securely exhibits. Furthermore, since the elastic contact segment and the elastic auxiliary segment are formed integrally on the cylindrical wall, structure thereof is made simple and compact.

The method of forming the female electrical contact part according to the second aspect further includes the steps of: just before cutting the elastic segment corresponding portion of the mountain-shaped portion from the top portion, or immediately after supporting the outer surface of the tip of the one elastic segment with the distal end of the other elastic segment, bending the unfolded cylindrical wall portion so as to form the cylindrical wall.

With the above structure, the mountain-shaped unfolded elastic segment corresponding portion is exactly formed into the required shape (required length, width and inclination angle) from the plate-shaped cylindrical wall portion by punching process and by bending process into mountain-like shape through press.

### Advantageous Effects of Invention

According to the first aspect of the invention, a brief and compact structure in which the elastic contact segment and the elastic auxiliary segment are formed integrally on the cylindrical wall allows for supporting the elastic contact segment by the elastic auxiliary segment during insertion of the male electrical contact part, securely exhibiting good contact load.

According to the invention, the front end portion of the elastic auxiliary segment is reliably supported by the rear end of the elastic contact segment without disengaging, always surely exhibiting good contact.

According to the invention, each elastic contact segment is support with the elastic auxiliary segment, surely exhibiting good contact load for the male electrical contact part reliably. In addition, integral formation of the elastic contact segment and the elastic contact segment on the cylindrical wall allows for the structure to be simple and compact.

According to the invention, integral formation of the elastic contact segment and the elastic auxiliary segment on the cylindrical wall allows for simple and compact structure of the female electrical contact part. Furthermore the elastic contact segment is supported by the elastic auxiliary segment upon insertion of the male electrical contact part into the female electrical contact segment, reliably exhibiting good contact load.

According to the invention, the mountain-shaped elastic segment corresponding portion is precisely and easily formed from the plate-shaped unfolded cylindrical wall portion.

### BRIEF DESCRIPTION OF THE DRAWINGS

FIG. 1 is a perspective view illustrating an embodiment of a female terminal including a female electrical contact part of the present invention;

FIG. 2 is an A-A cross-sectional view of FIG. 1 illustrating the female electrical contact part;

FIG. 3 is a sectional view illustrating a state of inserting the male connecting electrical contact part to the female electrical contact part;

FIG. 4 is a plane view illustrating a first step in one embodiment of a method of forming the female electrical contact part of the present invention;

FIG. 5 is a cross-sectional view illustrating a second step of the method of forming the female electrical contact part;

FIG. 6 is a cross-sectional view enlarging a principal part of FIG. 5;

FIG. 7 is a cross-sectional view illustrating a third step of the method of forming the female electrical contact part;

FIG. 8 is a cross-sectional view illustrating a fourth step of the method of forming the female electrical contact part;

FIG. 9 is a cross-sectional view illustrating an essential part of the finished female electrical contact part; and

FIG. 10 is a perspective view illustrating one embodiments of a related female electrical contact part.

### DETAILED DESCRIPTION OF THE PREFERRED EMBODIMENTS

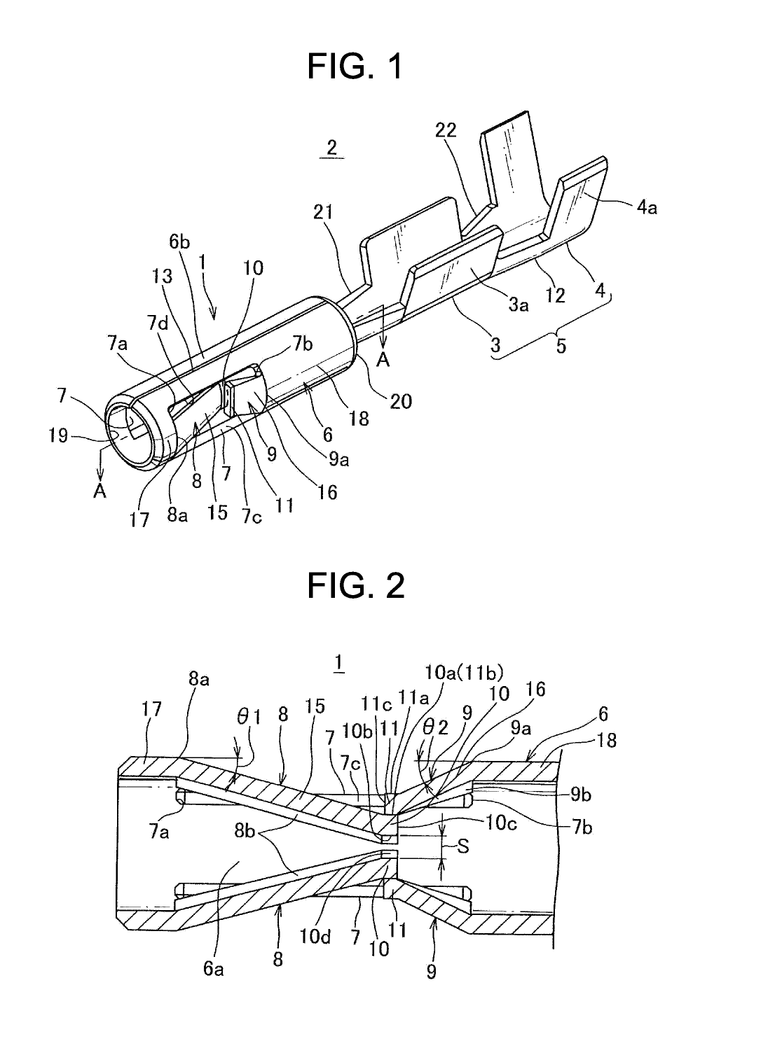

FIGS. 1 to 3 illustrate an embodiment of a female electrical contact part of the present invention.

As shown in FIG. 1, a female electrical contact part 1 is arranged in one of a female terminal 2 (the first half), and the other of the female terminal 2 (the second half) is provided with a core wire pressure contact part 3 and an insulating coating crimping section 4 as a front side and a rear side of a wire connecting portion 5, respectively. The female terminal 2 provided with the female electrical contact part 1 and the wire connecting portion 5 is integrally formed by punching and bending processes and the like from a sheet of conductive metal plates (not shown) that is a base material.

Other than the female terminal 2, the female electrical contact part 1 is formed as one of the female electrical contact part of relay terminal (a not-shown male electrical contact part may also be formed on the other delay terminal, and the similar female electrical contact part 1 may be formed) for example. Alternatively, the female electrical contact part 1 may be formed integrally on an end of a not-shown bus bar of conductive metal. This embodiment will be described as the female electrical contact part 1 that is formed on one of the terminals 2.

As shown in FIG. 1, the female electrical contact part 1 is provided with a cylindrical tubular wall 6, a pair of cutout holes 7 provided on the left and right of a front half of the cylindrical wall 6, a pair of elastic contact segments 8 inclined obliquely inward from the front (a front end of the cutout hole 7) toward a rear of the cylindrical wall 6, and a pair of elastic auxiliary segments 9 that protrudes inclined frontward and obliquely inward from a rear half of the cylindrical wall 6 (a rear end of the cutout hole 7) and abuts an inner surface of a distal end 11 (a front end) onto an outer surface of an distal end 10 (a free end or a rear end) of the pair of elastic contact segments 8 so as to support the pair of elastic contact segments 8 from outside.

In the description of the embodiments, by the term “front” is meant a side where the female electrical contact part 1 is positioned with respect to the female terminal 2, by the term “rear” a side where the wire connecting portion 5 is positioned, by the term “up” a direction in which each pressure contact piece of the wire connecting portion 5 with free state (before crimping) protrudes, by the term “down” a side where a bottom plate portion 12 of the wire connecting portion 5 is positioned, by the term “right and left” a direction in which a pair of pressure contact part 3 (4) is aligned facing the electric wire connecting portion 5, but are not necessarily coincident with a mounting direction of the female terminal 2.

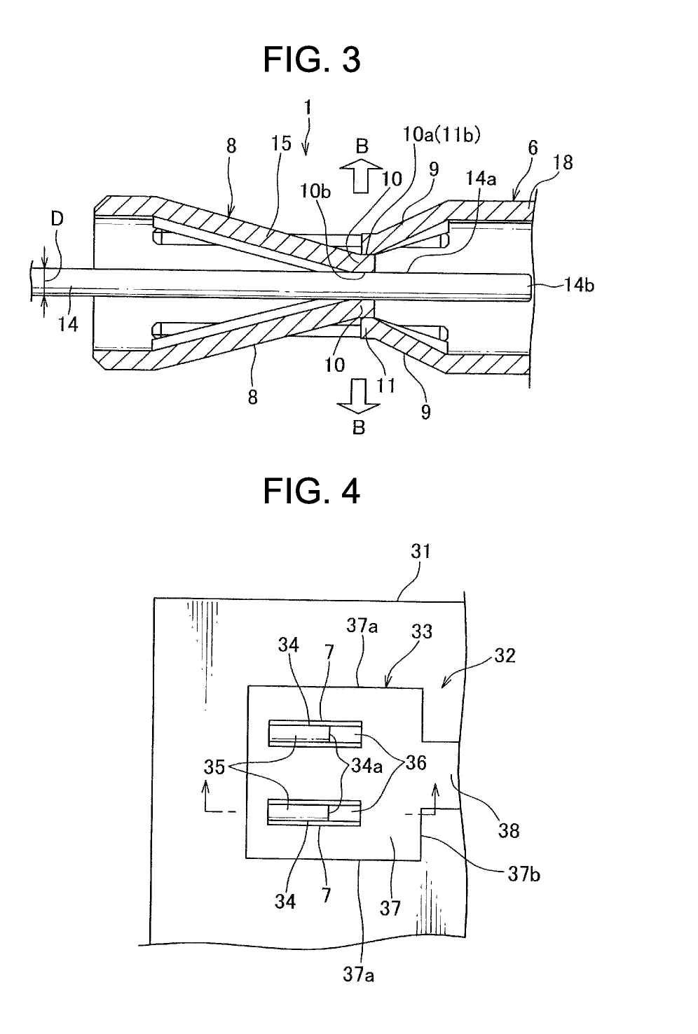

The cylindrical wall 6 of the female electrical contact part 1 includes a seam 13 in an axial direction (a terminal longitudinal direction) at its apex. The seam 13 is a joint portion when a not-shown metal plate as a base material is bend into a cylindrical shape, but does not open when the electrical contact part 14 of the mating male terminal (FIG. 3) is inserted.

The cutout hole 7 of the cylindrical wall 6 formed in the right and left are made in the case of punching the frontward elastic contact segment 8 and a rearward elastic auxiliary segment 9 from the metal plate (the base material). The cutout hole 7 forms horizontally long substantially rectangular shape along a longitudinal direction (an axial direction) of the elastic contact segment 8 and the elastic auxiliary segment 9. The cutout hole 7 has a vertical inner width larger than a vertical plate width of the elastic contact segment 8 or the elastic auxiliary segment 9. A length in the front and rear direction of the cutout hole 7 is shorter than a combination length of the overall lengths of the elastic contact segment 8 and the elastic auxiliary segment 9 (a method of processing the elastic contact segment 8 and the elastic auxiliary segment 9 will be described later).

After the front end of the cutout hole is followed integrally a proximal end 8a (a root) of the elastic contact segment 8. After the rear end of the cutout hole 7 is followed integrally the proximal end 9a (a root) of the elastic auxiliary segment 9.

The elastic auxiliary segment 9 is formed in the front and rear direction shorter than the elastic contact segment 8. In this example, the length of the elastic auxiliary segment 9 is less than a half length of the elastic contact segment 8. The elastic contact segment 8 and the elastic auxiliary segment 9 have cross-sectional outer and inner surfaces curved in the same manner as the cylindrical wall 6.

In the example of FIG. 1, a plate width of the elastic contact segment 8 from a base end 8a to the tip portion (a rear end) 10 may is uniform, but the tip portion 10 may be shrunk in a further tapered shape than the proximal end 8a. Similarly, a plate width of the elastic contact segment 9 from a base end 9a to the tip portion (a rear end) 11 may is uniform, but the tip portion 11 may be shrunk in a further tapered shape than the proximal end 9a.

The elastic contact segment 8 of the present example is constituted by an inclined piece 15 that is inclined diagonally inward from the front end of the cutout holes 7 toward an axial center of the cylindrical wall 6, and a tip portion 10 that is bent at the tip end of the inclined piece 15 substantially parallel to the shaft center of the cylindrical wall 6. Similarly, the elastic contact segment 9 of the present example is constituted by an inclined piece 16 that is inclined diagonally inward from the rear end of the cutout holes 7 toward the axial center of the cylindrical wall 6, and a tip portion 11 that is bent at the tip end of the inclined piece 16 substantially parallel to the shaft center of the cylindrical wall 6.

As shown in FIG. 2, the tip portion 10 of the elastic contact segment 8 includes an outer surface 10a and an inner peripheral surface 10b substantially parallel to the outer of the cylindrical wall 6, and the tip portion 11 of the elastic auxiliary segment 9 includes an outer surface 11a and an inner surface 10b substantially parallel to the outer surface and of the cylindrical wall 6. The inner surface 11b of the tip portion 11 of the elastic auxiliary segment 9 is contacted (abutted) on the outer surface 10a of the distal tip portion 10. The inner surface 10b of the tip portion 10 of the elastic contact segment 8 acts as a contact surface for the pin-like male terminal electrical contact part 14 in FIG. 3.

The pair of left and right elastic contact segments 8 are arranged opposite to each other in a direction of 180 degrees, the pair of right and left elastic auxiliary segments 9 are arranged opposite to each other in a direction of 180 degrees. An inclination inward degree 02 of elastic auxiliary segment 9 with respect to the cylindrical wall 6 is defined larger than an inclination inward angle θ1 of the elastic contact segment 8 with respect to the cylindrical wall 6.

A length of the axial length of the cylindrical wall 6 is defined corresponding to the pin-shaped male electrical contact part 14 (FIG. 3) of the mating male terminal. If the length of the male electrical contact part 14 is short, it is possible that the cylindrical wall 6 is formed shorter than that in FIG. 1, and that the elastic contact segment 8 and the elastic auxiliary segment 9 are formed across a length about two-thirds of the cylindrical wall 6 for example. On the front side of the front end or the rear side of the rear end of the cutout hole 7, an annular front end portion 17 and an annular rear end portion 18 of the cylindrical wall 6 are preferably arranged rigidly.

The front end portion 17 of the cylindrical wall 6 constitutes a nearly perfect circular wall (the seam 13 of the top is, as is bonded, said to be an almost complete annular wall). For example, the tip portion of the cylindrical portion 54 (the front end) in a conventional example of the female terminal 51 in FIG. 10 is divided in three slits 56, causing an edge of the front end thereof to easily catch to wires for example, which brings concern that a tip thereof may open if being caught, in contrast, the front end portion 17 of the cylindrical wall 6 of the present embodiment has no such a worry as above for example, it is also unnecessary to conduct a special control (such as protection of the front end portion 17) so as for the front end portion 17 not to catch the wire before inserting the female terminal 2 into a not-shown connector housing.

Also, as the cylindrical wall 6 of the present embodiment includes an outer surface with a uniform outer diameter over the entire length, except the cutout hole 7, and in the cutout hole 7 the elastic contact segment 8 and the elastic auxiliary segment 9 are also arranged further inward than the outer peripheral surface of the cylindrical wall 6, an insertion of the cylindrical wall 6 into the terminal housing of the not-shown connector housing is carried out smoothly without being caught. For example, in the conventional example of the female terminal 51 in FIG. 10, on the outside of the cylindrical portion 54 a spring ring 55 or a projection 57 for engaging and positioning a spring ring protrudes, which brings concern about being caught at the time of insertion into the connector housing. This embodiment of the cylindrical wall 6 causes no such worry, further, the cylindrical wall 6 is formed compactly in the radial direction, and thereby it is made possible to shrink the female terminal 2 in the radial direction and to narrow the terminal housing of the not-shown connector housing.

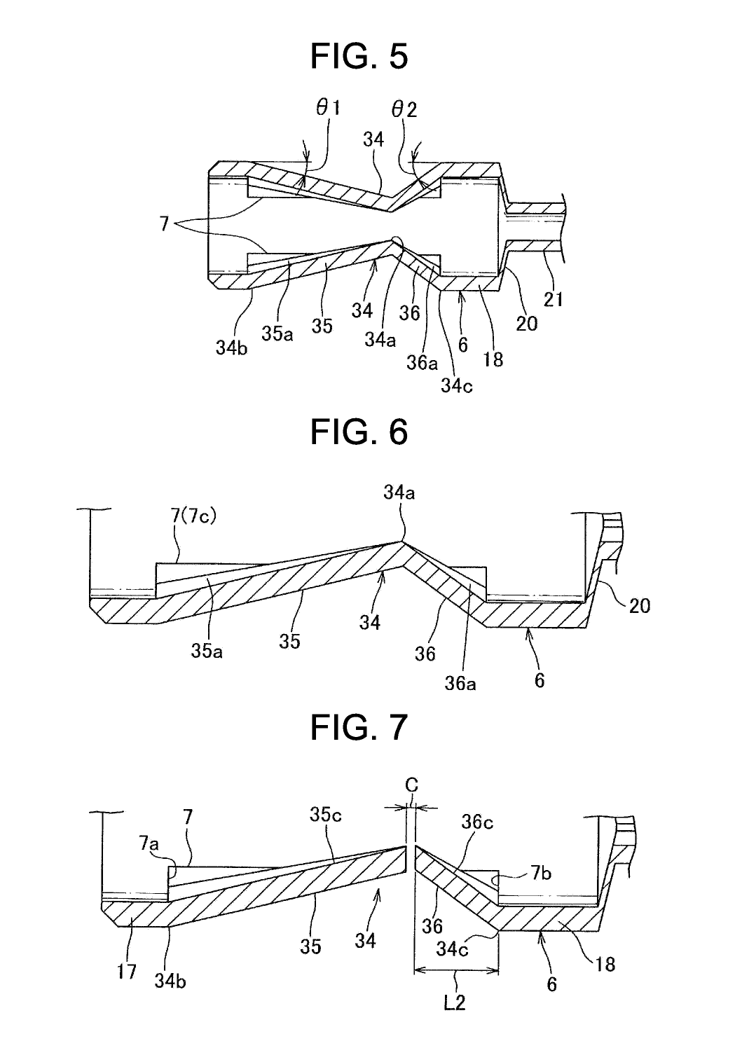

In FIG. 1, on the front end inner side of the cylindrical wall 6 is formed a circular opening 19 into which the pin-like electrical contact part 14 (FIG. 3) of the mating male terminal is inserted. The rear end of the cylindrical wall 6 is provided with a rear end wall 20 (FIG. 5) formed integrally, the rear end wall 20 follows integrally a neck 21 (a consolidated part) that is in the middle cross-sectionally U-shaped, narrow, and of low profile, the neck 21 follows integrally a front side wire pressure contact part 3 that is substantially cross-sectionally U-shaped, the front side wire pressure contact part 3 follows integrally the rear side wire pressure contact portion 4 of via a connecting portion 22 that is substantially cross-sectionally U-shaped. The front side wire pressure contact part 3, the connecting portion 22, and the rear side wire pressure contact portion 4 constitute the electric wire connecting portion 5. It is also possible to form the neck 21 into cross-sectionally not a U-shape but an annular shape.

FIG. 2 is an A-A sectional view of FIG. 1 (a diagram in which the female electrical connection 1 is horizontally cut). In the left and right cutout holes 7 of cylindrical wall 6, from the annular wall 17 of the front end side of the cylindrical wall 6 the pair of left and right the elastic contact segment 8 is inclined inwardly and protrudes rearward. Each inner surface 10b of the distal end portion (rear end) 10b of the pair of elastic contact segments 8 is opposed by a small gap S (e.g., a degree similar to a thickness of the plate of the elastic contact segment 8). In this state, the pair of left and right elastic auxiliary segments 9 protrudes forwardly inclined inwardly within each cutout hole 7 from the rear side annular wall 18 of the cylindrical wall 6, the inner surface 11b of the tip portion (the front end) of each elastic auxiliary segment 9 is in contact with or abuts onto the outer surface 10a of the tip portion (rear end) 10 of each of the elastic contact segment 8, and thereby the tip portion 11 of each elastic auxiliary segment 9 supports the distal tip portion 10 of the elastic contact segment 8 from outside.

Thus, the pair of elastic contact segments 8 is suppressed to open outward (bending). Each elastic auxiliary segment 9 is, as formed shorter in half or less than the pair of elastic contact segments 8, has higher rigidity than the elastic contact segment 8. The male terminal of the electrical contact part 14 is inserted between the pair of elastic contact segments 8 (FIG. 3), the elastic auxiliary segment 9 suppresses each elastic contact segment 8 to open outwardly (bending), and acts as increasing a contact load against the male electrical contact part 14 (contact pressure). Gap S between the tip portions 10 of the pair of elastic contact segments 8 in FIG. 2 is defined smaller than the outer diameter D of the male electrical contact part 14 (FIG. 3). For example, the dimension of the gap S is generally two-thirds the outer diameter D of the male electrical contact part 14.

For example, while the pair of elastic contact segments 8 is inclined inwardly in a free state should the elastic auxiliary segment 9 not be used, in the example of FIG. 2 the inner surface 11b of the distal tip portion 11 of the elastic auxiliary segment 9 may be contacted to the outer surface 10a of the distal tip portion 10 of each elastic contact segment 8 inclined inward in a free state (in this case, it is no problem if there is a slight gap between the outer surface 10a of the tip portion 10 of the elastic contact segment 8 and the inner surface 11b of the tip portion 11 of and the elastic auxiliary segment 9), or the inner surface 11b of the distal tip portion 11 of the elastic auxiliary segment 9 may be contacted or abutted on the outer surface 10a of the distal tip portion 10 of each of the elastic contact segment 8 against outward biasing force (elastic force) of the elastic contact segment 8.

In the example of FIG. 2, the distal tip portion 11 of each of the elastic auxiliary segment 9 is located between vertical end faces of the cutout hole 7 of the cylindrical wall 6 (along vertical end surfaces) in a plan view, or slightly further inward toward the axial center of the cylindrical wall 6 than the vertical end faces. The thickness of each the elastic auxiliary segment 9 in the present example is nearly equal to that of each elastic contact segment 8. An inclination angle θ1 in this example of each elastic contact segment 8 with respect to the cylindrical wall 6 is around 15 degrees, an inclination angle θ2 of the elastic auxiliary segment 9 with respect to the cylindrical wall 6 is around 25 degrees, each elastic contact segments 8 is gently inclined, and the elastic auxiliary segment 9 is inclined steeper than then elastic contact segments 8. Thus, opening (deflection) movement of each elastic contact segment 8 can effectively be suppressed with each elastic auxiliary segment 9 of high rigidity. The pair of elastic contact segments 8 is formed symmetrically, and the pair of elastic auxiliary segments 9 is formed symmetrically.

The tip portion (rear end) 10 of each elastic contact segment 8 is bent so as to intersect saliently with an inclined piece 15 of the elastic contact segment 8, the tip portion 10 is positioned in the axial direction so that the outer surface 10a and the inner surface 10b of the tip portion 10 lie parallel to the cylindrical wall 6. The distal end surface (rear end face) 10c of the distal tip portion 10 faces rearward. A length of the tip portion 10 of this example is generally one-tens length of the inclined piece 15.

Similarly, the distal end portion (front end portion) 11 of each elastic auxiliary segment 9 is bent so as to intersect saliently with the inclined piece 16 of the elastic contact segment 9, the elastic contact with the outer surface 11a and the inner surface 11b of the distal tip portion 11 lie parallel to the outer surface 10a and the inner surface 10b of the distal tip portion 10 of the elastic contact segment 8. The distal end surface (the front end surface) 11c of the distal tip portion 11 faces forward. An imaginary line of the tip portion 11 extending frontward intersects with a longitudinal intermediate portion of the inclined piece 15 the elastic contact segment 8. A length of the tip portion 11 is equal to that of the distal end 10 of the elastic contact segment 8. The length of the tip portion 10 is generally one-fourths length of the inclined piece 16.

The proximal end 8a of each elastic contact segment 8 continues to the front annular wall portion 17 of the cylindrical wall 6, intersecting obtusely, each proximal end 9a of each the elastic auxiliary segment 9 continues to the rear half side annular wall portion 18 of the cylindrical wall 6, intersecting obtusely with at a steeper slope than the proximal end 8a of the elastic contact segment 8.

In FIG. 2, the portion indicated in the inner surface of the elastic contact segment 8 is a curved lower half portion 8b of the elastic contact segment 8, the distal tip portion 10 of each elastic contact segment 8 also has a curved lower half portion 10d in the same manner. The curved lower half portion 8b continues and intersects to the front side annular wall 17 of the cylindrical wall 6. The same applies to the curved upper half of not-shown curved upper half portion. In the example of FIG. 2, a curved lower half portion 9b shown on the inside of the elastic auxiliary segment 9 is slightly curved or not almost curved, and the curved shape of the lower half portion 9b increases gradually toward the base end portion 9a. The curved lower half portion 9b continues and intersects to the annular wall 18 of the rear half of the cylindrical wall 6.

In FIG. 2, lower end surfaces 7c of the left and right cutout holes 7 of the cylindrical wall 6 longitudinally extend so as to intersect in a plan view a longitudinal direction intermediate portion of each elastic contact segment 8 and the distal tip portion 11 of each elastic auxiliary segment 9. The front end 7a of each cutout hole 7 is located on the same virtual vertical plane as the proximal end (base) 8a of each elastic contact segment 8, and the rear end 7b of each cutout hole 7 is located on the same virtual vertical plane as the proximal end (base) 9a of each elastic auxiliary segment 9. The lower end surface 7c of the respective cutout holes 7 is located radially inside of the cylindrical wall 6, a cross-sectionally arc-shaped bottom wall portion 6a of the cylindrical wall 6 is located between lower end surfaces 7c of each cutout hole 7 in a plan view. The same is applied to the upper surface, as shown in FIG. 1, a cross-sectionally arc-shaped upper wall 6b of the cylindrical wall 6 is located between the upper end surfaces 7d of each cutout hole 7 in a plan view.

The female terminal 2 (FIG. 1) having the female electrical contact part 1 in FIG. 2 is housed in a terminal receiving chamber of the not shown connector housing made of synthesis (insulated) resin, constituting a connector. The terminal receiving chamber is provided with a large rear opening for insertion of the terminal 2a, and a narrow front opening for inserting the male electrical contact part 14 of the mating male terminal (FIG. 3). The terminal receiving chamber is provided with a terminal locking arm, with which a rear end wall 20 of the cylindrical wall 6 is locked, for example, at a neck 21 in the middle of the female terminal 2 in FIG. 1.

A rear end wall 20 of the cylindrical wall 6 is formed in an annular shape in a rear view, operably locking the terminal locking arm in the connector housing in the rear end wall 20 in a range of 360 degrees in the circumferential direction of the cylindrical wall 6, making it possible to engage by freely inserting the female terminal 2 in the range of 360 degrees in the circumferential direction as far as using the pin-like male electrical contact part 14 (FIG. 3) for example without positioning circumferentially the cross-sectionally circular female terminal 2 in the terminal receiving chamber of cross-sectional circular shape. In many cases the terminal receiving chamber is plurally provided in parallel in the connecter housing.

FIG. 3 illustrates a state in which the pin-like male electrical contact part 14 which is male terminal made of conductive metal is inserted into and connected to the female electrical contact part 1 of FIG. 2. The male electrical contact part is cross-sectionally circular, and has a uniform outer diameter in the whole length (excluding a tip 14b)

The male terminal has the pin-like male electrical contact part 14 on the one side and the wire connecting portion (5) similar to the female terminals 2 on the other side. Alternatively, for example, the male terminal only of the pin-shaped male electrical contact part 14 is formed integrally with a not-shown bus bar made of conductive metal, or is connected to a not shown circuit board so as to be formed protruding.

In addition, it is also possible to use an stab-like (flat) male electrical contact part (not shown) instead of the pin-like male electrical contact part 14. In this case, the tab-like male electrical contact part is arranged to match its thickness direction with the left and right direction, and the right and left outer surfaces (contact surfaces) of the tab-like male electrical contact part abuts onto the inner surface of each left and right female electrical sections 8 of the female contact part 1. However, in this case, it is necessary to position circumferentially the female terminal 2 with respect to the tab-like male electrical contact portions. To use the tab-shaped male electrical contact part may enable the cylindrical wall 6 to be a rectangular cross-sectional shape other than circular cross sectional shape. In FIG. 3 a case using a pin-like male electrical contact part 14 will be described.

The male terminal having the male electrical contact part 14 on the one, the wire connecting portion on the other is housed in and engaged with the terminal receiving chamber of the terminal housing made of synthetic resin, and the male electrical contact part 14 protrudes into and is arranged in the connector engagement chamber of the connector housing. A connector (consisting of at least the female terminal 2 and the connector housing) accommodating the female terminal 2 (FIG. 1) is fitted in the connector engagement chamber, and the female electrical contact part 14 of the male terminal is inserted into and connected to the female electrical contact part 1 of the female terminal 2.

As shown in FIG. 3, the pin-like male electrical contact part 14 is inserted between the tip portion 10 of the pair of elastic contact segments 8 of the female electrical contact part 1, and thereby the tip portion 10 of the pair of elastic contact segments 8 while opening (or is bent) outward as shown by the arrow B in the width dimension equal to the outer diameter D of the male electrical contact part 14, presses the pair of elastic auxiliary segment 9 radially outward to be bent. The pair of elastic auxiliary segments 9 presses inwardly the pair of elastic contact segments 8 by elastic restoring force (spring force) when deflected by outward.

Thereby, the male electrical contact part 14 is strongly held between the pair of elastic contact segments 8 with the sum spring force of that of the pair of elastic contact segment 8 and that of the pair of elastic auxiliary segments 9, and is reliably connected with a good contact load (pressure). The inward spring force of the pair of elastic auxiliary segments 9 is delivered to the male electrical contact part 14 via the pair of elastic contact segments 8. It is only the elastic contact segment 8 that contacts the pair of male electrical contact part 14.

In the example of FIG. 3 the inner surface 10b of the distal tip portion 10 of the pair of elastic contact segment 8 is in contact with the peripheral surface 14a of the male electrical contact part 14, and when the outer diameter D of the male electrical contact part 14 is larger than is in FIG. 3, the inner surface 10b of the tip portion 10 of the pair of elastic contact segment 8 and an inner surface of the inclined piece 15 following the tip portion 10 (vicinity of the distal tip portion 10) at the same time contact the outer peripheral surface 14a of the male electrical contact part 14. The tip 14b of the male electrical contact part 14 of the example in FIG. 3, penetrating between the distal tip portion 10 of the pair of elastic contact segments 8, passes through between the pair of elastic auxiliary segments 9, and reaches in the rear half of the annular wall 18 of the cylindrical wall 6.

Upon insertion of the male electrical contact part 14, the sum spring force of the elastic contact segment 8 as a main spring and the auxiliary spring segment 9 as an auxiliary spring can provide a larger contact load than is without the elastic auxiliary segment 9, securing with the female electrical contact part 1 of the one component an electric connection performance similar to the conventional female electrical contact part 52 of the two components shown in FIG. 10 for example.

In FIG. 3, for example, even not only in the case that the male electrical contact part 14 is inserted slightly diagonally relative to the axial direction of the female electrical contact part 1, but in the case that the female electrical contact part 1 is vibrated while the connector is mounted in a vehicle, as the outer surface 10a of the distal tip portion 10 of each the elastic contact segment 8 and the inner surface 11b of the end 11 of each elastic auxiliary segment 9 are in firm surface contact, it is free from the distal end 11 of the elastic auxiliary segment 9 being disengaged from the distal tip portion 10 of the elastic contact segment 8, thereby improving the reliability of the electrical connection by the sum spring force of the elastic contact segment 8 and the elastic auxiliary segment 9 respective to the male electrical contact part 14.

In the following, with reference to FIGS. 4-9, a first embodiment of a method of forming a female electrical contact part of the present invention will be described.

First, as shown in FIG. 4, an unfolded shape body 32 of a female terminal 2 (FIG. 1) is formed from a single flat conductive metal plate (base material) 31 with a punching press (not shown). In FIG. 4 the unfolded shape portion 33 of the contact part 1 (FIG. 1) of the female electrical female terminals 2 is only illustrated, and an unfolded shape portion of the wire connecting portion 5 (FIG. 1) is omitted.

The unfolded shape portion 33 of the female electrical contact part 1 is provided with a pair of substantially rectangular cutout hole 7, and an elastic segment corresponding portion (elastic segment unfolded shape portion) 34 integrally continuous in the longitudinal direction (cutout hole longitudinal direction) within each cutout hole 7 that are at the same time or separately formed by pressing process. In the punching process of FIG. 4, the pair of elastic segment corresponding portions 34 is formed to protrude upward or downward into substantially mountain shape respective to the cylindrical-wall-unfolded-shape portion 37. In FIG. 6 a top of each elastic segment corresponding portion 34 is denoted by the reference numeral 34a.

Each elastic segment corresponding portion 34 in an upward mountain-shape is simultaneously formed by previously forming a recess portion in the upper mold of the press (not shown) and a projecting portion (vice versa in the case of downward) in the lower mold. Extension in the mountain shape of each elastic segment corresponding portion 34 in comparison with the planner cylindrical-wall-unfolded-shape portion 37 (FIG. 4) makes the elastic segment corresponding portion 34 near the top portion 34a a little thinner than the cylinder wall unfolded shape portion 37.

The first half side of the long piece portion 35 of each elastic segment corresponding portion 34 corresponds to the elastic contact segment 8 of the female terminal 2 in FIG. 1, the second half side of the short piece portion 36 of the elastic segment corresponding portion 34 corresponds to the elastic auxiliary segment 9 of the female terminal 2 in FIG. 1. A portion excepting the cutout hole 7 and the elastic segment corresponding portion 34 is cylindrical-wall-unfolded-shape portion 37. The unfolded shaped portion 38 of the neck 21 (FIG. 1) follows rearward the cylindrical-wall-unfolded-shape portion 37, the unfolded shape portion of the wire connecting portion 5 (FIG. 1) of not-shown one front and rear pair is punched to be formed at a rear side of the neck unfolded shaped portion 38.

Then, as shown in FIGS. 5 and 6 (an enlarged view of FIG. 5), the unfolded shape portion 33 of the female electrical contact part 1 in the terminal unfolded shape body 32 punched in FIG. 4 is rounded to the right and left direction (flexion). The right and left ends 37a of the cylindrical-wall-unfolded-shape portion 37 becomes the seam 13 of the top portion of the cylindrical wall 6 of FIG. 1. The cylindrical-wall-unfolded-shape portion 37 (FIG. 4) is roundly processed (bent) so that a right and left mountain-shaped pair elastic segment corresponding portions 34 protrudes toward inside the cylindrical wall 6.

In FIGS. 5 and 6, the mountain-shaped elastic segment corresponding portion 34 is pressed when punching in FIG. 4 (curved lower half portion of a long piece 35 and a short piece portion 36 are respectively denoted by 35a and 36a), in order to be curved shape in a circumferential direction similarly to the cylindrical wall 6 across the top portion 34a, the front side long piece portion 35, the rear side short piece portion 36, and each of the rear and front side base ends (base) 34b and 34c. An inclination angle θ1 of the long piece portion 35 relative to the cylindrical wall 6 is set small and an inclination angle θ2 of the short piece portion 36 is set large. The top portion 34a of the mountain-like elastic segment corresponding portion 34 protrudes further inward toward an axial center of the cylindrical wall 6 than the lower end 7c of the cutout hole 7.

The cylinder-wall-unfolded-shape portion 37 (FIG. 4) in a circumferential direction is rounded, for example, by pressing or cold forging, etc. At the same time as rounding the cylinder-cylindrical-wall-unfolded-shape portion 37, the rear end 37b (FIG. 4) of the cylindrical-wall-unfolded-shape portion 37 is bent, the annular rear end wall 20 of the cylindrical wall 6 is formed. The unfolded shape portion of the neck portion 38 (FIG. 4) and that (not shown) of each of rear and front wire pressure contact part 3 and 4 (FIG. 1) are raised upward by bending through pressing, forming U-shaped section of the neck portion 21 and each of the rear and front electrical wire crimping units 3 and 4. An annular wall 18 of the second half in the exemplified cylindrical wall of FIG. 5 is formed shorter in the axial direction than the exemplified cylindrical wall 6 of FIG. 1.

Then, as shown in FIG. 7, each mountain-shaped elastic segment corresponding portion 34 is cut at the top portion (top recesses) 34a (the cutting portion is indicated by the symbol C). Each elastic segment corresponding portion 34 is cut, for example, by a pair of not-shown left and right metal cutters advancing toward inside from radially outside of the cylindrical wall and one not-shown die that is arranged inside of the cylindrical wall 6, supports each elastic segment corresponding portion 34, 36c, and has a recess for having the cutter advance. Each cutter is driven back and forth by left and right press machines or so.

The pair of left and right cutters cut concurrently inward the top (most recessed portion) 34a of each mountain-shaped elastic segment corresponding portion 34 (FIG. 6). A cutting allowance (C) is preferably narrow. Cutting of the elastic segment corresponding portion 34 (FIG. 6) at its top portion 34a allows the front side long pieces (one elastic segment) 35 and the rear side short piece portion (other elastic segment) 36 to be formed cantilevered by the cylindrical wall 6 respectively. The front side long piece portion 35 is cantilevered at the front side base end (root) 34b by the front end 7a of the cutout hole 7, namely, the annular wall 17 of the front side of the cylindrical wall 6, and the rear side short piece portion 36 is cantilevered at the rear side base end (root) 34c by the rear end 7b of the cutout hole 7, namely, the rear side annular wall 18 of the cylindrical wall 6. The long piece portion 35 corresponds to the elastic contact segment 8 in FIG. 1.

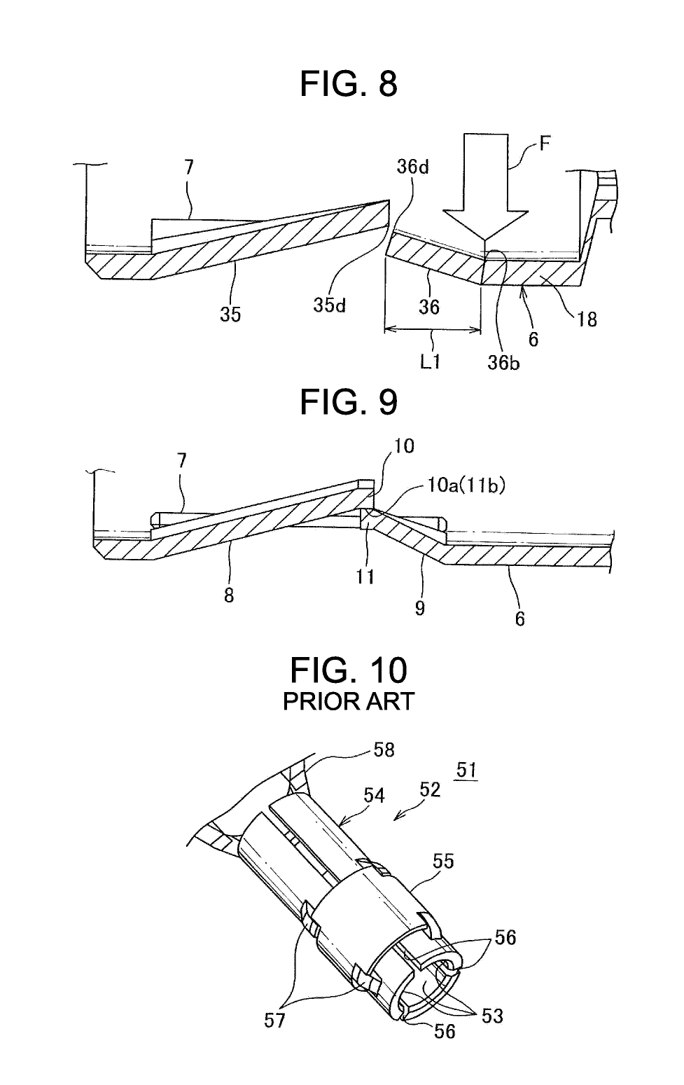

Then, as indicated by the arrow F in FIG. 8, striking the base portions (base portion) 36b of the right and left pair of short piece portions 36, namely, an intersection portion of the rear side annular wall 18 of the cylindrical wall 6 moves and deforms the short piece portions 36 to a lower portion than the long piece portions 35, namely, radially outward. Releasing of a striking force forces the short piece portion 36 to spring back from a struck state in FIG. 8 slightly inward, contacting (abutting) with no gap an inner end 36d near the tip of the short piece portion 36 to an outer end 35d near the tip end of the long piece portion 35. It follows from this that the tip of the long piece portion 35 is supported from outside at the distal end of the short piece portion 36.

The striking process is, for example, easily made in such a manner that inside the short piece portions 36, the base portion 36b of the short piece portion 36 is applied to a die (not shown) and the base portion 36b of the short piece portions 36 is struck with press machine or the like from outside opposite to the arrow F. It is also possible to insert the striking jig inside (not shown) the cylindrical wall 6 and to strike the base portion 36b of the short piece portion 36 in the direction of the arrow F with the striking jig from inside of the cylindrical wall 6.

Striking process of FIG. 8 plastically deforms the short piece portion 36 into an inclined state somewhat low-gradient from a state inclined steep in FIG. 7, stretching an axial distance (not the total length) L1 of the short piece portions 36 longer than an axial distance L2 in FIG. 7. Thus, the inner end 36d of the distal end side of the short piece portion 36 is in contact or brought into contact with the front end side of the outer end 35d of the long piece portion 35. In striking step of FIG. 8, it is no problem that a minimum gap is generated between an inner end 36d near the front end of the short piece portion 36 and the outer end 35d near the end of the long piece portion 35.

In FIG. 8 pulling and stretching the short piece portions 36 in a direction of the front end (free end) instead of striking the base portion 36b of the short piece portion 36 (applying the pressing force in the arrow F direction) may place the short piece portion 36 lower than the long piece portions 35 (radially outward). This stretch processing is made, for example, in such a manner that the short piece portion 36 is elastically bent from the state of FIG. 7 outside of the long piece portion 35, and in such a moved (relief) state as shown in FIG. 8 the distal end portion of the short piece portion 36 is gripped by a chuck and is pulled obliquely forward with a cylinder or the like. In this case, the cylindrical wall 6 is kept immovably fixed, pressed with a press machine or the like.

For example, in a (relief) state that the short piece portion 36 is elastically bent outside the long piece portion 3, compressing the short piece portion 36 in a thickness direction with press machine or the like may stretch the short piece portion 36. Striking or stretching process of the short piece portion 36 in FIG. 8 forms an elastic auxiliary segment similar to the elastic auxiliary segment 9 in FIG. 1. The front side long piece portion 35 is made an elastic contact segment similar to the elastic contact strip 8 in FIG. 1.

Furthermore, in FIG. 8, bending outwardly and plastically deforming in parallel the distal end portion of the long piece portion (elastic contact segment) 35 and the distal portion of the short piece portion 36 (elastic auxiliary segment) forms a distal tip portion 10 of the elastic contact segment and the tip portion 11 of the elastic auxiliary segment 9 in FIG. 9. Then the outer surface 10a of the distal tip portion 10 of the elastic contact segment 8 and the inner surface 11b of and the tip portion 11 of the elastic auxiliary segment 9 are brought into surface contact. The elastic contact segment (35) and the elastic auxiliary segment (36) can actually be used with each distal ends 10 and 11 being formed.

Also, instead of stretching the short piece portions 36 in the stretching process in FIG. 8, with the long strip 35 from a state in FIG. 7 being bent highly inwardly (a state of relief from the short piece portion 36 inward), pulling backward and stretching the long piece portion 35 toward the distal end side may position in higher radially inward the long piece portion 35 higher than the short piece portions 36. In this case, the cylindrical-wall-unfolded-shape portion 37 is kept immovably fixed by pressing with press machine or the like. Since the position of the short piece portion 36 remains at the position of FIG. 7, the long piece portion 35, remaining with an outward restoring force in a state reflected inwardly suppress an outward deflection at the tip of the short piece portion 36.

Alternatively, as shown in FIG. 8, while the short piece portion 36 is extended by striking or pulling, the long piece portion 35 may in addition be pulled and stretched, an outer surface of the end portion of the long piece portion 35 is received at the inner end 36d of the tip of the short piece portion 36. In either case, as shown in FIG. 9, tip portions 10 and 11 are each formed parallel to the long piece portion (elastic contact segment) 35 and the short piece part (elastic auxiliary segments) 36.

In the method of forming the female electrical contact part of the first embodiment, a cylindrical-wall-unfolded-shape portion 37, the cutout hole 7 and the mountain-shaped elastic segment corresponding portion 34 are formed in the punching step in FIG. 4, the cylindrical-wall-unfolded-shape portion 37 is then rounded (bent), followed by the elastic segment corresponding portion 34 being cut in this state.

In contrast, as the second embodiment, it is possible that in the punching process of FIG. 4 the cylindrical-wall-unfolded-shape portion 37, the cutout hole 7, and the elastic segment corresponding portion 34 as shown in FIG. 6 are formed before with the state of the unfolded shape the mountain-shaped elastic segment corresponding portion 34 is cut as shown in FIG. 7 and still in the state of the unfolded shape the base 36d of the cut short piece portion (other elastic segment) 36 is struck and the short piece portion 36 is stretched, or the short piece portion 36 is pulled and stretched, or the long piece part is pulled and is stretched, and the elastic auxiliary segment 9 that is the short piece portion 36 in FIG. 9 is positioned lower than the elastic contact segment 8 that is the long piece portion 35, then the tip end of the short piece portion 36 is abutted onto the tip end of the long piece portion 35.

Then, the cylindrical-wall-unfolded-shape portion 37 is round (bend) as FIG. 5 so that the elastic contact segment 9 that is the long piece portion 35 and the elastic auxiliary segment 8 that is the short piece portion 36 are positioned in a radial direction. In the second embodiment, the elastic segment corresponding portion 34 and the cut long piece portion 35 and short piece portion 36 are similarly shown in FIGS. 6 to 9, the cylindrical cylindrical-wall-unfolded-shape portion 37 and the cutout hole 7 are shown in a plan view.

In the second embodiment, formation of the elastic segment corresponding portion 34 in FIG. 6 is omitted because it is similar to the first embodiment. Cutting of the elastic segment corresponding portion 34 of FIG. 7 is, for example, in the unfolded state in FIG. 6 in the state that the mountain-shaped elastic segment corresponding portion 34 is received in a not-shown mountain-shaped lower mold, the not-shown metal cutter is vertically descended from upside with a press machine. A vertical groove is provided in the lower mold to enter the tip of the cutter.

A process of striking the base portion 36b of the short piece portion 36 to be the elastic auxiliary segment in FIG. 8 is performed in such a manner that, for example, the lower (outer) surface of the pre-cut long piece portion 35 is fully received by a not-shown inclined surface of the lower mold, a not shown inclined surface of the lower mold is oppositely arranged with a gap under the lower face of the short piece portion 36, and the base portion 36b of the short piece portion 36 is struck in this state with the press machine or the like. The short piece portion struck in the base portion 36 abuts onto the not-shown inclined surface of the lower mold, preventing further opening and deformation downward (outward) than it already is. The short piece portion 36 is located lower and further outward than the long piece portion 35.

Instead of tapping the short piece portion 36 of FIG. 8, the step of pulling and stretching the short piece portion 36, for example, in FIG. 7, in a state that the long piece portion 35 is deflected (escaped) elastically downward as required, the short piece portions 36 is compressed in the plate thickness direction with not-shown upper and lower press dies so as to stretch in front and rear direction.

Further, instead of pulling or striking the short piece portion 36 of FIG. 8, the step of pulling the long piece portion 35 in FIG. 7 is made such that with the short piece portions 36 bent (relieved) downward (outward) as shown in FIG. 8 from the state of FIG. 7, the tip portion of the long piece portion 35 is chucked and pulled obliquely rearward with not-shown cylinder or the like. In this case, the cylindrical-wall-unfolded-shape portion 37 is kept pressed with a press machine or the like. The long piece portion 35 is located higher and further inward than the short piece portion 36.

Also, as shown in FIG. 9, the step of forming the tip portions 10 and 11 parallel to the long piece portion 35 and the short piece portions 36 is made such that from the state of FIG. 8, the tip end side of the inclined long piece portion 35 is bent or pressed, and is gripped by a chuck or the like so as to become horizontal, after or before that, the tip end side of the inclined short piece portion 36 is chucked by a chuck or the like, and is bent or pressed so as to become horizontal.

Then, the cylindrical cylindrical-wall-unfolded-shape portion 37 is rounded with a press mold, etc., left and right side end faces of the cylinder wall unfolded shape portion 37 are jointed with a top seam 13 to be a cylindrical wall, so as to be the female electrical contact portion 1 in FIG. 1. The cylindrical-wall-unfolded-shape portion 37 is exactly rounded so that the elastic contact segment that is the long piece portion 35 and the elastic auxiliary segment that is the short piece portion 36 are located inside of the cylindrical wall 6. Bending and raising process of the unfolded shape portion of the electrical wire connection portion 5 (FIG. 1) is preferred to be performed at the same time as the rounding process of the cylindrical-wall-unfolded-shape portion 37.

Note that in the method of forming the female electrical contact part and the female electrical contact part in the above embodiment, although the left and right pair of elastic contact segment 8 and elastic auxiliary segment 9 is each formed, it is also possible for example to form three, four, or more pairs of elastic contact segment 8 and elastic auxiliary segment 9. This method of forming is similar to that of the second embodiment. Each of three pairs of elastic contact segment 8 and elastic auxiliary segment 9 are arranged at 120-degree intervals in the circumferential direction of the cylindrical wall 6, and one pair of elastic contact segment 8 and elastic auxiliary segment 9 is arranged opposed to the seam 13 of the cylindrical wall 6 beneath the cylindrical wall 6.

In addition, it is also possible to form singly the cutout hole 7 and the elastic contact segment 8 and the elastic auxiliary segment 9 in the cylindrical wall 6. In this case, each of the cutout hole 7, the elastic contact segment 8, and the elastic auxiliary segment 9 are formed on the bottom wall 6a of the cylindrical wall 6, and for example, the upper wall portion including the seam 13 of the cylindrical wall is formed, fitted in a diameter of the male electrical contact part 14 (so as to follow the outer circumferential surface 14a), into a cross-sectionally substantially semicircular shape in smaller diameter than the bottom wall 6a side.

Also, as described above, it is also possible to form the cylindrical wall 6 of the female electrical contact part 1 into a cross-sectionally rectangular shape (not shown) other than cross-sectionally circular shape. In that case, the left and right vertical side walls and a upper and lower horizontal wall portions form the cylindrical wall (6), and each cutout hole 7, the elastic contact segment 8 and the elastic auxiliary segment 9 raised inwardly from the cutout portion are provided in not cross-sectionally arc-shaped but cross-sectionally flat. The cylindrical wall 6 is bent rather than rounded.

In addition, it is possible to appropriately modify the female electrical contact part and the method of forming the female electrical contact part of the present invention according to conventional known knowledge. A configuration of the female electrical contact part and the method of forming the female electrical contact part is, as long as is provided through such modifications, intended to be included in the scope of the present invention.

### INDUSTRIAL APPLICABILITY

The female electrical contact part and the method for forming the female electrical contact part of the present invention, can be utilized to reliably exhibit good contact load with respect to the male electrical contact part in a simple and compact structure.

### DESCRIPTION OF SYMBOLS

1 female electrical contact part
6 cylindrical wall
7 cutout hole
7a front end
7b rear end
8 elastic contact segment
9 elastic auxiliary segment
10 tip (rear end)
10a outer surface
11 tip (front end)
11b inner face
14 male electrical contact part
19 opening
34 elastic segment corresponding portion
34a top
35 long piece part (one elastic segment)
36 short piece part (the other elastic segment)
37 cylindrical wall unfolded shape portion
C cutting portion

What is claimed is:

1. A female electrical contact part comprising:
a cylindrical wall having an opening arranged at a front end for inserting a male electrical contact part;
a cutout hole provided on the cylindrical wall at a position spaced rearward from the opening;
an elastic contact segment protruding diagonally rearward from a front end of the cutout hole toward inside of the cylindrical wall; and
an elastic auxiliary segment protruding diagonally forward from a rear end of the cutout hole toward inside of the cylindrical wall and supporting at a front end portion an outer surface of a rear end portion of the elastic contact segment.

2. The female electrical contact part according to claim 1, wherein
the outer surface of the rear end portion of the elastic contact segment and an inner surface of the front end portion of the elastic auxiliary segment are in surface contact.

3. The female electrical contact part according to claim 1, wherein
the cutout hole, the elastic contact segment, and the elastic auxiliary segment are provided in one or more pairs on the cylindrical wall.

4. The female electrical contact part according to claim 2, wherein
the cutout hole, the elastic contact segment, and the elastic auxiliary segment are provided in one or more pairs on the cylindrical wall.

5. A method of forming a female electrical contact part, comprising:
cutting and raising a mountain-shaped elastic segment corresponding portion at a plate-like cylindrical-wall-unfolded-shape portion made of conductive metal;
cutting the mountain-shaped elastic segment corresponding portion from a top portion so as to form one elastic segment and the other elastic segment;
punching or drawing the other elastic segment so as to lie lower and further outward than the one elastic segment, or drawing the one elastic segment so as to lie higher and further inward than the other elastic segment;
supporting an outer surface of a distal end of the one elastic segment as an elastic contact segment with a distal end of the other elastic segment as an elastic auxiliary segment.

6. The method according to claim 4, further comprising:
bending the cylindrical-wall-unfolded-shape portion so as to form the cylindrical wall just before cutting the mountain-shaped elastic segment corresponding portion from a top portion, or just after supporting an outer surface of a tip portion of the one elastic segment with a tip portion of the other elastic segment.
